(19) United States
(12) Patent Application Publication
(10) Pub. No.: US 2025/0211835 A1
(43) Pub. Date: Jun. 26, 2025

(54) DYNAMIC PRECISION MARGIN FOR VIDEO SCRUBBING

(71) Applicant: Axis AB, Lund (SE)

(72) Inventors: Samuel ASTEBERG, Lund (SE); Markus ANDERSSON, Lund (SE)

(73) Assignee: Axis AB, Lund (SE)

(21) Appl. No.: 18/393,759

(22) Filed: Dec. 22, 2023

(51) Int. Cl. H04N 21/845; H04N 21/2183; H04N 21/472

(52) U.S. Cl. CPC H04N 21/8455; H04N 21/2183; H04N 21/47217

(57) ABSTRACT

In some implementations, a client device may detect user input indicating a requested time along a timeline of a video, the video being stored at a server device. The client device may check if a cached image having a timestamp within a precision margin of the requested time is stored in a memory of the client device. Under a condition that the cached image is present in the memory, the client device may retrieve the cached image from the memory of the client device. Under a condition that the cached image is not present in the memory, the client device may retrieve a corresponding image from the server device. The client device may adjust a size of the precision margin to be proportional to a length of the timeline such that the size of the precision margin proportionally increases and decreases with the length of the timeline.

### BACKGROUND

Scrubbing is a technique that enables a user (e.g., via using a client device) to navigate through data, such as video data. For example, scrubbing enables users to explore and interact with specific points or sections within a dataset by manipulating a control element along a designated axis or timeline.

### SUMMARY

Some implementations described herein relate to a method of retrieving images from a server device for video scrubbing at a client device. The method may include detecting, by a client device, user input indicating a requested time along a timeline of a video, the video stored at the server device; checking, by the client device, if a cached image having a timestamp within a precision margin of the requested time is stored in a memory of the client device; under a condition that the cached image is present in the memory, retrieving, by the client device, the cached image from the memory of the client device; under a condition that the cached image is not present in the memory, retrieving, by the client device and from the server device, a corresponding image; and adjusting, by the client device, a size of the precision margin to be proportional to a length of the timeline such that the size of the precision margin proportionally increases and decreases with the length of the timeline.

Some implementations described herein relate to a system for retrieving images from a server device for video scrubbing at a client device. The system may include one or more processors communicatively coupled to the one or more memories. The one or more processors may be configured to detect user input indicating a requested time along a timeline of a video, the video stored at the server device; check if a cached image having a timestamp within a precision margin of the requested time is stored in a memory of the client device; under a condition that the cached image is present in the memory, retrieve the cached image from the memory of the client device; and under a condition that the cached image is not present in the memory, retrieve, from the server device, a corresponding image, wherein a size of the precision margin is proportional to a length of the timeline such that the size of the precision margin proportionally increases and decreases with the length of the timeline.

Some implementations described herein relate to a non-transitory computer-readable medium storing a set of instructions, the set of instructions comprising: one or more instructions that, when executed by one or more processors of a device, cause the device to: detect user input indicating a requested time along a timeline of a video, the video stored at the server device; check if a cached image having a timestamp within a precision margin of the requested time is stored in a memory of the client device; under a condition that the cached image is present in the memory, retrieve the cached image from the memory of the client device; under a condition that the cached image is not present in the memory, retrieve, from the server device, a corresponding image; and adjust a size of the precision margin to be proportional to a length of the timeline such that the size of the precision margin proportionally increases and decreases with the length of the timeline.

### BRIEF DESCRIPTION OF THE DRAWINGS

FIGS. 1A-1D are diagrams of an example associated with retrieving images from a server device for video scrubbing at a client device using a precision margin that is dynamically changeable in proportion to changes of a length of a timeline, in accordance with some embodiments of the present disclosure.

FIG. 2 is an example environment in which systems and/or methods described herein may be implemented.

FIG. 3 is a diagram of example components of a device associated with retrieving images from a server device for video scrubbing at a client device using a precision margin that is dynamically changeable in proportion to changes of a length of a timeline, in accordance with some embodiments of the present disclosure.

FIG. 4 is a flowchart of an example process associated with retrieving images from a server device for video scrubbing at a client device using a precision margin that is dynamically changeable in proportion to changes of a length of a timeline, in accordance with some embodiments of the present disclosure.

### DETAILED DESCRIPTION

The following detailed description of example implementations refers to the accompanying drawings. The same reference numbers in different drawings may identify the same or similar elements.

A video scrubbing system enables a user to navigate a temporal structure of a video via interaction with a graphical element, such as a timeline displayed via a user interface (e.g., of a client device) associated with the video scrubbing system. For example, the video scrubbing system typically provides a timeline including visual markers, such as pixels, that are positioned along the timeline. Each position of the visual markers along the timeline is associated with a specific time (e.g., a specific timestamp) corresponding to a specific image (e.g., a specific frame) of the video (e.g., which is associated with a specific time position in the video).

Furthermore, a length of the timeline is typically adjustable (e.g., adjustable between one or more zoom levels that increase or decrease the length of the timeline) causing a density of the visual markers along the timeline to vary (e.g., a number of pixels representing each unit of time of the timeline may vary). As an example, if the length of the timeline at a first zoom level is 5 minutes, then each second of the timeline may be represented by a single pixel. As another example, if the length of the timeline is 30 seconds, then each second may be represented by multiple pixels.

To navigate the temporal structure of the video, the user provides user input indicating specific times along the timeline (e.g., by causing a slider to move to positions of the visual markers along the timeline). In response to detecting the specific times, the video scrubbing system performs video scrubbing. As an example, the video scrubbing system retrieves (e.g., fetches), from a device (e.g., a server device) storing the video, specific images corresponding to the specific times (e.g., the specific timestamps) and displays the specific images (e.g., via the user interface to enable the user to view the specific images of the video).

However, retrieving the specific images from the device consumes resources and introduces latency and delays (e.g., associated with video decoding, image extraction, image storage, image display, and network latency, among other examples). To avoid retrieving the specific images from the device, the video scrubbing system typically stores the specific images in a memory cache of the video scrubbing system using the specific timestamps as cache keys having a fixed time resolution, such as a fixed time resolution of 1 second, and retrieves the specific images from the memory cache. Accordingly, if the user subsequently indicates one of the specific times (e.g., already indicated by the user), then the video scrubbing system retrieves the corresponding specific image from the memory cache rather than retrieving the corresponding specific image from the device.

However, because the video scrubbing system stores and retrieves images (e.g., based on user input) using cache keys having a fixed time resolution, it is, in some cases, difficult for the video scrubbing system to effectively utilize the memory cache. For example, if each second of a timeline having a 20 minute duration is represented by a single pixel, and if the video scrubbing system uses cache keys having a fixed time resolution of one second, then the user input would need to indicate a specific time more than once, which has a low probability of occurring based on the fixed time resolution and the pixel density, to enable the video scrubbing system to retrieve a cached image corresponding to the specific time. Additionally, if the user has not already scrubbed back and forth through the timeline to store a relatively large number of images, then there is a high likelihood that an image is not available in the memory cache for a desired point in time on the timeline.

Furthermore, even if the video scrubbing system effectively utilizes the memory cache when the timeline is at a first zoom level, the video scrubbing system may not be able to effectively utilize the memory cache when the timeline changes to a second zoom level (e.g., because the fixed time resolution is not associated with a length of the timeline). As an example, if each second of a first timeline at a first zoom level (e.g., associated with a 30 second timeline) is represented by multiple pixels, and if each second of a second timeline at a second zoom level (e.g., associated with a 20 minute timeline) is represented by a single pixel, then the video scrubbing system may be able to effectively utilize the memory cache when performing video scrubbing associated with the first timeline but cannot effectively utilize the memory cache when performing video scrubbing associated with the second timeline. As a result, the video scrubbing system cannot effectively utilize the memory cache (e.g., the video scrubbing system retrieves images from the device rather than the memory cache, stores images at a slow rate, and stores images that are not subsequently retrieved) leading to consumption of resources (e.g., processing, network, and memory resources, among other examples) and introduction of latency and delays.

Some implementations described herein enable dynamic changes to a precision margin (e.g., used by a client device for video scrubbing) in proportion to a change in a length of a timeline. For example, a client device may detect user input indicating a requested time along a timeline of a video, the video stored at the server device. The client device may check if a cached image having a timestamp within a precision margin of the requested time is stored in a memory of the client device. The client device may, under a condition that the cached image is present in the memory, retrieve the cached image from the memory of the client device. The client device may, under a condition that the cached image is not present in the memory, retrieve a corresponding image from the server device. The client device may adjust a size of the precision margin to be proportional to a length of the timeline such that the size of the precision margin proportionally increases and decreases with the length of the timeline.

Because the client device changes the size of the precision margin in proportion to changes in the length of the timeline, the client device effectively utilizes the memory cache regardless of the length of the timeline. In other words, rather than utilizing cache keys having a fixed time resolution, the client device uses a precision margin that is dynamically changeable in proportion to changes in the length of the timeline. Furthermore, because the client device retrieves the cached image or the corresponding image based on the user input for video scrubbing, rather than using pre-downloaded images for video scrubbing, the client device populates the memory cache of the client device on demand. As a result, the client device conserves resources, optimizes memory space, and optimizes resources associated with retrieving images from the server device for scrubbing at the client device.

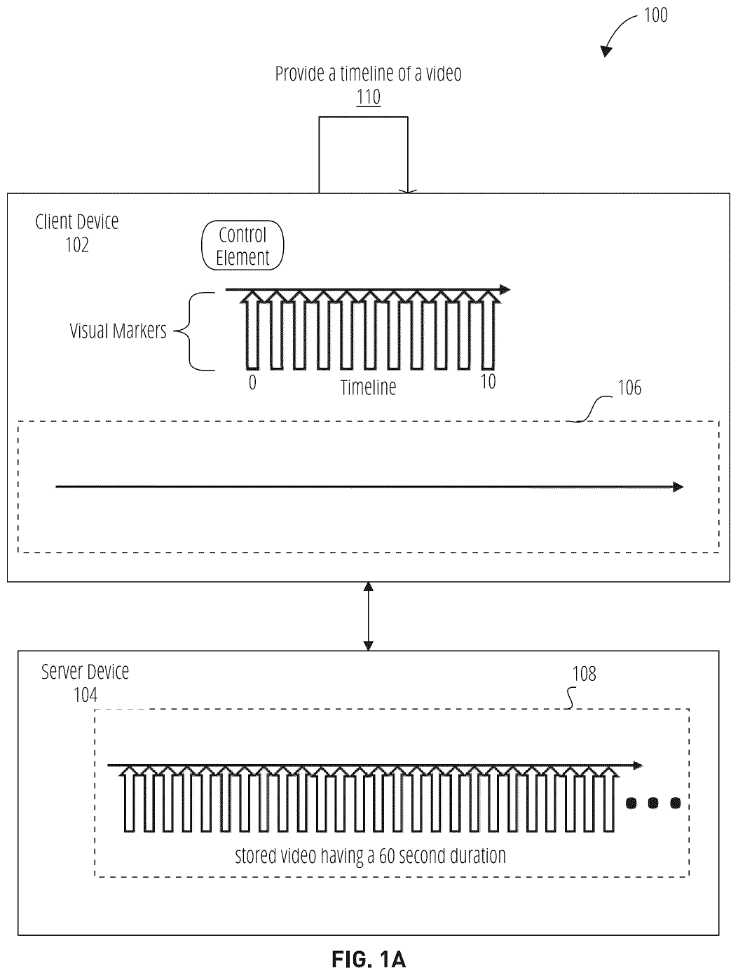

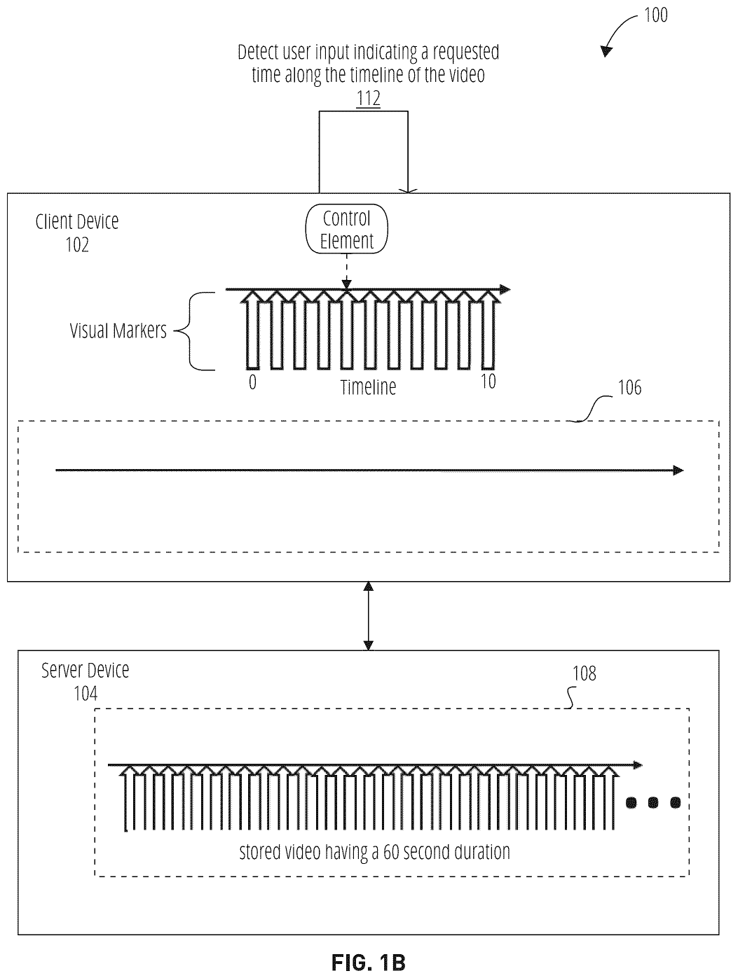

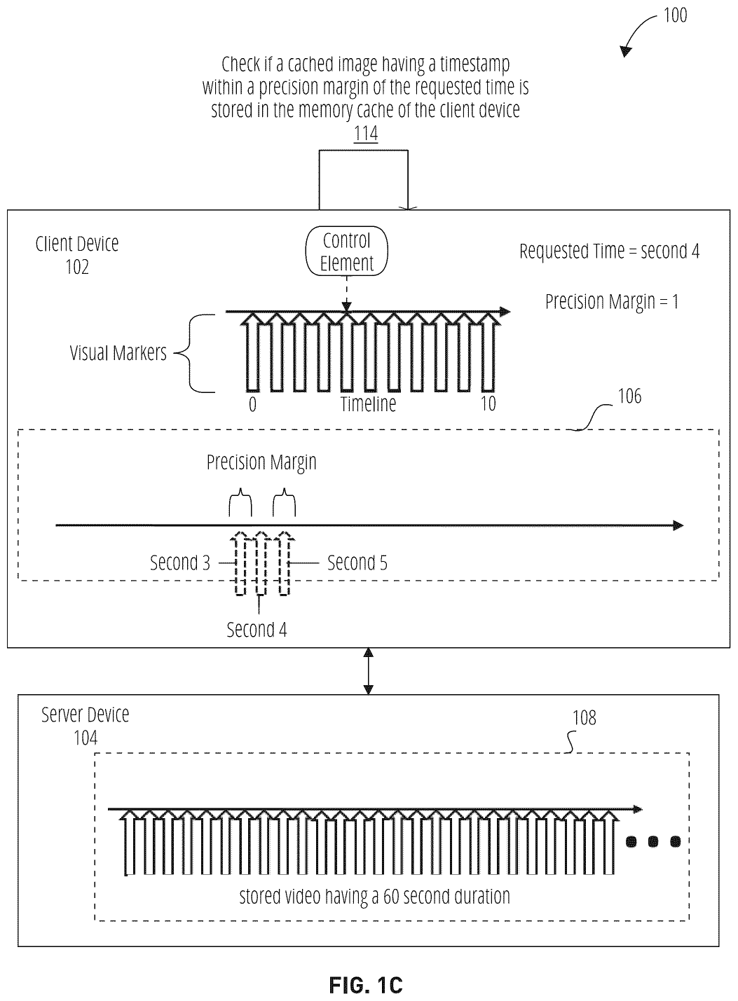

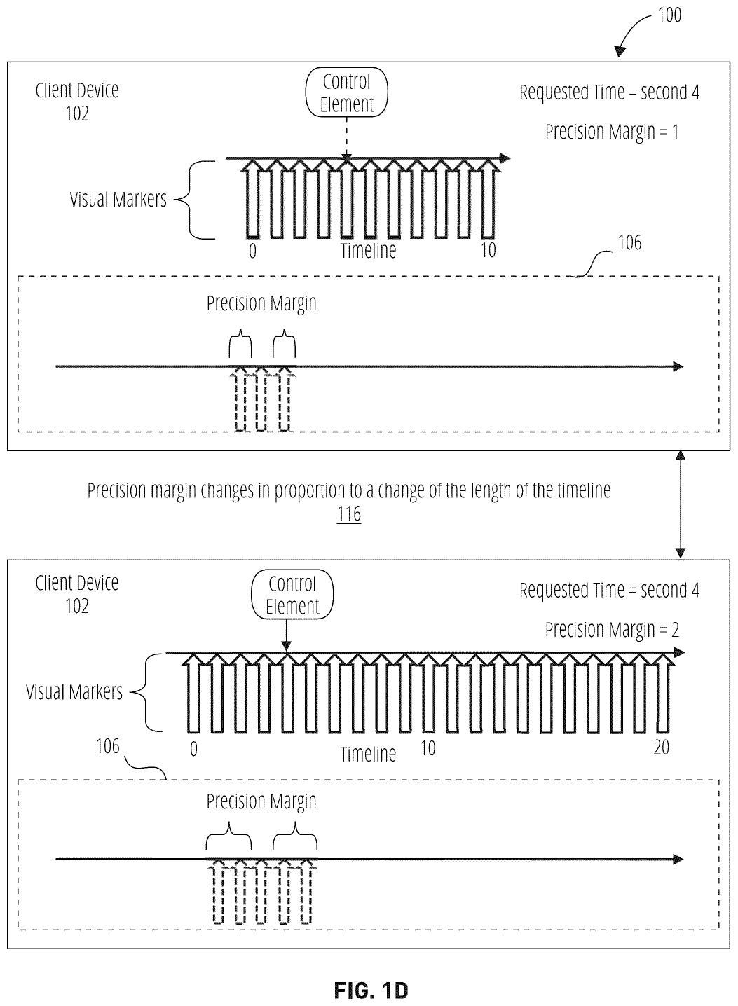

FIGS. 1A-1D are diagrams of an example 100 associated with retrieving images from a server device for video scrubbing at a client device using a precision margin that is dynamically changeable in proportion to changes of a length of a timeline. The precision margin is a dynamically changeable, in proportion to changes of a length of the timeline, time resolution associated with video scrubbing performed by the client device 102. Accordingly, a size of the precision margin may be adjusted to be proportional to the length of the timeline such that the size of the precision margin proportionally increases and decreases with the length of the timeline. For example, if the timeline changes from a first length to a second length, then the precision margin changes from a first value to second value in proportion to the changes from the first length to the second length, as described in more detail elsewhere herein. Accordingly, the client device 102 may store (e.g., in the memory cache 106) and retrieve (e.g., from the memory cache 106) images of the video using cache keys (and/or any other suitable caching technique) that have a precision margin that is dynamically changeable in proportion to changes in the length of the timeline.

As shown in FIGS. 1A-1D, example 100 includes a client device 102 and a server device 104. As further shown in FIGS. 1A-1D, the client device 102 includes a memory cache 106 and the server device 104 includes a database 108. These devices are described in more detail in connection with Figs. and 2 and 3.

As shown in FIG. 1A, and by reference number 110, the client device 102 provides (e.g., via a user interface of the client device 102) a timeline of a video (e.g., shown as a video having a 60 second duration that is stored at the server device 104). The timeline includes visual markers (e.g., shown as arrows in FIG. 1A) positioned along a length of the timeline. Each position of the visual markers along the timeline is associated with a particular time (e.g., a particular timestamp) corresponding to a particular image (e.g., a particular frame) of the video (e.g., which is associated with a particular time position in the video). As shown in FIG. 1A, the timeline includes visual markers at positions associated with second 0 through second 10 (e.g., associated with timestamps indicating second 0 through second 10), which correspond to images of the video associated with time positions of second 0 through second 10 in the video.

As shown in FIG. 1B, and by reference number 112, the client device 102 detects user input indicating a requested time along the timeline of the video. As an example, the client device 102 may detect the user input indicating the requested time along the timeline of the video in response to a user of the client device 102 moving a graphical element (e.g., shown as a control element in FIG. 1B) to a position of a visual marker (e.g., shown as a position of a visual marker associated with second 4 in FIG. 1B). Accordingly, for example, the user input indicating the requested time along the timeline is a selection of a visual marker (e.g., a pixel) positioned along the length of the timeline.

In some implementations, the user input indicating the requested time along the timeline of the video is selected from available times along the timeline of the video that are associated with an event, such as detection of motion in the video. The client device 102 may perform one or more actions based on the user input indicating the requested time along the timeline, as described in more detail elsewhere herein.

As shown in FIG. 1C, and by reference number 114, the client device 102 checks if a cached image having a timestamp within a precision margin of the requested time is stored (e.g., is present) in the memory cache 106 of the client device 102. The client device 102 may perform one or more operations based on whether the cached image having the timestamp within the precision margin of the requested time is present in the memory cache 106 of the client device 102.

For example, under a condition that the cached image is present in the memory cache 106 of the client device 102, the client device 102 may retrieve the cached image from the memory cache 106 of the client device 102. As another example, under a condition that the cached image is not present in the memory cache 106 of the client device 102, the client device 102 may retrieve a corresponding image (or corresponding images) from the server device 104 (e.g., from the database 108 that is storing the video), as described in more detail elsewhere herein. The client device 102 may store the corresponding image in the memory cache 106 of the client device 102 and may use the corresponding image for video scrubbing (e.g., the client device 102 may present the corresponding image to the user via the user interface).

As shown in FIG. 1C, for example, the requested time along the timeline is second 4 (e.g., based on the user input) and the precision margin is 1 second (e.g., which is proportional to the length of the timeline). Thus, the client device 102 checks if cached images corresponding to images of the video with a time position in the video of second 3, second 4, and second 5 (e.g., between second 3 and second 5) are present in the memory cache 106 of the client device 102.

As shown in FIG. 1C, the cached images corresponding to the images of the video with the time position in the video of second 3, second 4, and second 5 are not present in the memory cache 106 of the client device 102 (e.g., because the client device 102 has not yet stored any images in the memory cache 106 of the client device 102). Based on the cached images corresponding to the images of the video with the time position in the video of second 3, second 4, and second 5 not being present in the memory cache 106 of the client device 102, the client device 102 retrieves images of the video with the time position in the video of second 3, second 4, and second 5 from the server device 104. Although the client device 102 is shown and described as retrieving multiple corresponding images (e.g., images of the video with the time position in the video of second 3, second 4, and second 5) from the server device 104, the client device 102 may retrieve any suitable number of corresponding images (e.g., one or more of the images of the video with the time position in the video of second 3, second 4, and second 5).

In this way, the client device 102 may dynamically retrieve and store images in the memory cache 106 of the client device 102 based on the user input. In other words, the memory cache 106 may be populated by the client device 102 on demand based on user input.

As shown in FIG. 1D, and by reference number 118, the precision margin changes (e.g., dynamically) in proportion to changes of the length of the timeline. For example, if the user zooms in or out on the timeline (e.g., compared to a default length of the timeline), then the precision margin changes in proportion to changes of the length of the timeline. As another example, if the recorded video is shorter or longer than the default length of the timeline, then the precision margin changes in proportion to the changes of the length of the timeline.

In this way, the client device 102 may adjust the size of the precision margin to be proportional to the length of the timeline such that the size of the precision margin proportionally increases and decreases with the length of the timeline. As shown in FIG. 1D, the timeline changes from a length of 10 seconds to a length of 20 seconds (e.g., based on the user zooming out). In response to the length of the timeline changing from 10 seconds to 20 seconds, the precision margin changes from 1 second to 2 seconds (e.g., via the client device 102 adjusting the precision margin in proportion to the change in the length of the timeline), which is proportional to the change in length of the timeline from 10 seconds to 20 seconds.

In some implementations, the precision margin may be user-settable (e.g., the user may interact with the user interface if the client device 102 to set the precision margin). For example, the user may set the precision margin to any suitable value, such as 1 second, 2 seconds, or 3 seconds, among other examples, such that the selected precision margin is proportional to the length of the timeline. Although the precision margin is described as being user-settable and adjustable to be proportional to the length of the timeline, the precision margin may be any suitable precision margin that dynamically changes in proportion to changes in the length of the timeline.

As indicated above, FIGS. 1A-1D are provided as an example. Other examples may differ from what is described with regard to FIGS. 1A-1D.

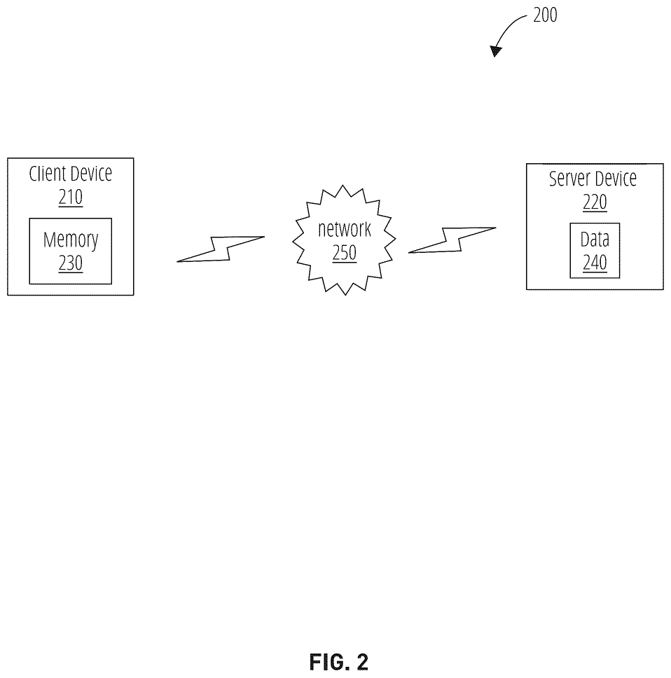

FIG. 2 is a diagram of an example environment 200 in which systems and/or methods described herein may be implemented. As shown in FIG. 2, environment 200 may include a client device 210 (e.g., which may correspond to the client device 102), a server device 220 (e.g., which may correspond to the server device 104), a memory 230 (e.g., which may correspond to the memory cache 106), data 240 (e.g., which may be stored by the server device 220), and a network 250. Devices of environment 200 may interconnect via wired connections, wireless connections, or a combination of wired and wireless connections.

The client device 210 may include one or more devices capable of receiving, generating, storing, processing, and/or providing information associated with retrieving images from a server device for video scrubbing at a client device using a precision margin that is dynamically changeable in proportion to changes of a length of a timeline, as described elsewhere herein. The client device 210 may include a communication device and/or a computing device. For example, the client device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), and/or a similar type of device.

The server device 220 may include one or more devices capable of receiving, generating, storing, processing, providing, and/or routing information associated with retrieving images from a server device for video scrubbing at a client device using a precision margin that is dynamically changeable in proportion to changes of a length of a timeline. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. The server device 220 may, e.g., be a network camera, such as a surveillance camera. In some implementations, the server device 220 may include computing hardware used in a cloud computing environment.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). The memory 230 may be a non-transitory computer-readable medium. The memory 230 may store information, one or more instructions, and/or software (e.g., one or more software applications) related to present disclosure. In some implementations, the memory 230 may include one or more memories that are coupled (e.g., communicatively coupled) to one or more processors, such as via a bus. Communicative coupling between the one or more processors and the memory 230 may enable the one or more processors to read and/or process information stored in the memory 230 and/or to store information in the memory 230.

The data 240, which may be stored by the server device 220, may include information associated with retrieving images from a server device for video scrubbing at a client device using a precision margin that is dynamically changeable in proportion to changes of a length of a timeline, as described in more detail elsewhere herein. The data 240 may include any suitable data, such as video streams, audio streams, subtitles, and/or metadata, among other examples. The data 240 may be stored in any suitable container format, such as the Matroska Multimedia Container (MKV). Additionally, the data 240 may be encoded using any suitable codec, such as H.264.

The network 250 may include one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

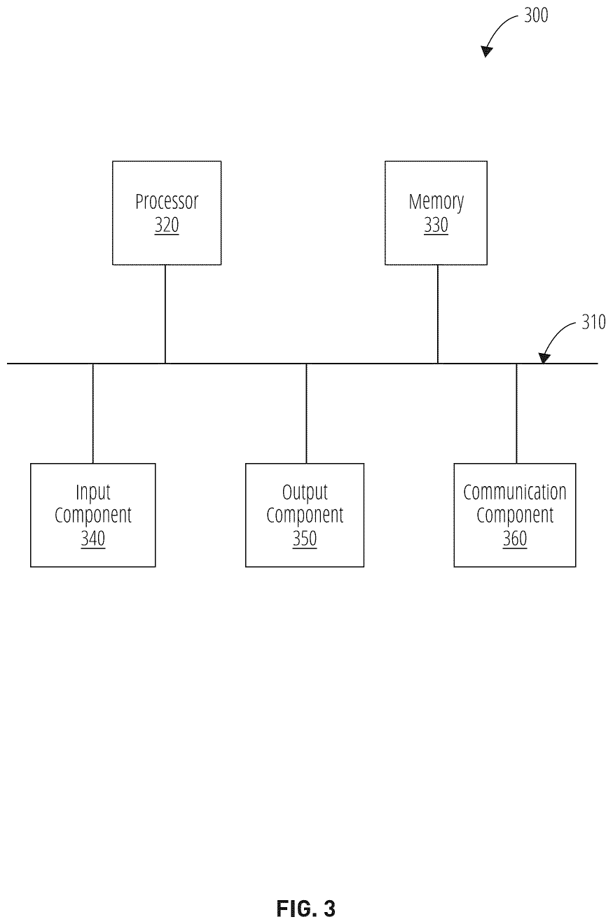

FIG. 3 is a diagram of example components of a device 300 associated with retrieving images from a server device for video scrubbing at a client device using a precision margin that is dynamically changeable in proportion to changes of a length of a timeline. The device 300 may correspond to the client device 102, the server device 104, the memory cache 106, the database 108, the client device 210, the server device 220, and/or the memory 230. In some implementations, the client device 102, the server device 104, the memory cache 106, the database 108, the client device 210, the server device 220, and/or the memory 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory (e.g., in a similar or same manner as described in connection with the memory 230). In some implementations, the memory 330 may include one or more memories that are coupled (e.g., communicatively coupled) to one or more processors (e.g., the processor 320), such as via the bus 310. Communicative coupling between the one or more processors and the memory 330 may enable the one or more processors to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

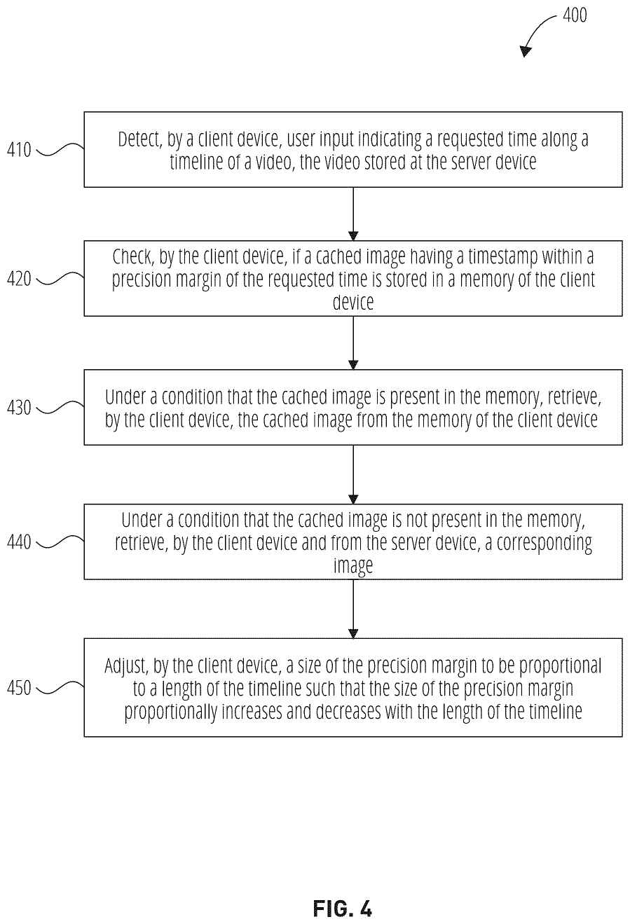

FIG. 4 is a flowchart of an example process 400 associated with retrieving images from a server device for video scrubbing at a client device using a precision margin that is dynamically changeable in proportion to changes of a length of a timeline. In some implementations, one or more process blocks of FIG. 4 may be performed by the client device 102. In some implementations, one or more process blocks of FIG. 4 may be performed by another device, or a group of devices, separate from or including the client device 102, such as the server device 104, the memory cache 106, the database 108, the client device 210, the server device 220, and/or the memory 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include detecting, by a client device, user input indicating a requested time along a timeline of a video (e.g., a video stored at a server device) (block 410). For example, the client device may detect user input indicating a requested time along a timeline of a video, as described above.

As further shown in FIG. 4, process 400 may include checking, by the client device, if a cached image having a timestamp within a precision margin of the requested time is stored in a memory of the client device (block 420). For example, the client device may check if a cached image having a timestamp within a precision margin of the requested time is stored in a memory of the client device, as described above.

As further shown in FIG. 4, process 400 may include, under a condition that the cached image is present in the memory, retrieving, by the client device, the cached image from the memory of the client device (block 430). For example, the client device may, under a condition that the cached image is present in the memory, retrieve the cached image from the memory of the client device, as described above.

As further shown in FIG. 4, process 400 may include, under a condition that the cached image is not present in the memory, retrieving, by the client device and from the server device, a corresponding image (block 440). For example, the client device may, under a condition that the cached image is not present in the memory, retrieve a corresponding image from the server device, as described above.

As further shown in FIG. 4, process 400 may include adjusting, by the client device, a size of the precision margin to be proportional to a length of the timeline such that the size of the precision margin proportionally increases and decreases with the length of the timeline (block 450). For example, the client device may adjust a size of the precision margin to be proportional to a length of the timeline such that the size of the precision margin proportionally increases and decreases with the length of the timeline, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of retrieving images from a server device for video scrubbing at a client device, the method comprising:
detecting, by a client device, user input indicating a requested time along a timeline of a video, the video stored at the server device;
checking, by the client device, if a cached image having a timestamp within a precision margin of the requested time is stored in a memory of the client device;
under a condition that the cached image is present in the memory, retrieving, by the client device, the cached image from the memory of the client device;
under a condition that the cached image is not present in the memory, retrieving, by the client device and from the server device, a corresponding image; and
adjusting, by the client device, a size of the precision margin to be proportional to a length of the timeline such that the size of the precision margin proportionally increases and decreases with the length of the timeline.

2. The method of claim 1, wherein the size of the precision margin is adjusted in response to a change in a zoom level of the timeline that changes the length of the timeline.

3. The method of claim 1, further comprising:
setting an initial size of the precision margin to be proportional to a default length of the timeline corresponding to a default zoom level.

4. The method of claim 1, wherein the length of the timeline is less than a length of the video.

5. The method of claim 1, further comprising:
under a condition that the client device retrieves the cached image from the memory of the client device, displaying the cached image via a user interface of the client device; and
under a condition that client device retrieves the corresponding image, displaying the corresponding image via the user interface of the client device.

6. The method of claim 1, wherein the user input indicating the requested time along the timeline of the video is a selection of a visual marker positioned along the length of the timeline corresponding to the requested time along the timeline of the video.

7. The method of claim 1, wherein the requested time along the timeline of the video is selected from available times along the timeline of the video that are associated with an event occurring in the video.

8. A system for retrieving images from a server device for video scrubbing at a client device, the system comprising:
one or more memories; and
one or more processors, communicatively coupled to the one or more memories, configured to:
detect user input indicating a requested time along a timeline of a video, the video stored at the server device;
check if a cached image having a timestamp within a precision margin of the requested time is stored in a memory of the client device;
under a condition that the cached image is present in the memory, retrieve the cached image from the memory of the client device; and
under a condition that the cached image is not present in the memory, retrieve, from the server device, a corresponding image,
wherein a size of the precision margin is proportional to a length of the timeline such that the size of the precision margin proportionally increases and decreases with the length of the timeline.

9. The system of claim 8, wherein the one or more processors are configured to:
detect a change in the length of the timeline; and
adjust the size of the precision margin to be proportional to the change in the length of the timeline.

10. The system of claim 8, wherein the one or more processors are configured to:
detect user input indicating a desired zoom level associated with a particular length of the timeline;
change the length of the timeline to the particular length of the timeline; and
adjust the size of the precision margin to be proportional to the particular length of the timeline.

11. The system of claim 8, wherein the one or more processors are configured to:
set an initial size of the precision margin to be proportional to a default length of the timeline corresponding to a default zoom level.

12. The system of claim 8, wherein the length of the timeline is less than a length of the video.

13. The system of claim 8, wherein the one or more processors are configured to:
under a condition that the cached image is retrieved from the memory of the client device, display the cached image via a user interface of the client device; and
under a condition that corresponding image is retrieved from the server device, display the corresponding image via the user interface of the client device.

14. The system of claim 8, wherein the user input indicating the requested time along the timeline of the video is a selection of a visual marker positioned along the length of the timeline corresponding to the requested time along the timeline of the video.

15. A non-transitory computer-readable medium storing a set of instructions, the set of instructions comprising:
one or more instructions that, when executed by one or more processors of a device, cause the device to:
detect user input indicating a requested time along a timeline of a video, the video stored at the server device;
check if a cached image having a timestamp within a precision margin of the requested time is stored in a memory of the client device;
under a condition that the cached image is present in the memory, retrieve the cached image from the memory of the client device;
under a condition that the cached image is not present in the memory, retrieve, from the server device, a corresponding image; and
adjust a size of the precision margin to be proportional to a length of the timeline such that the size of the precision margin proportionally increases and decreases with the length of the timeline.

16. The non-transitory computer-readable medium of claim 15, wherein the one or more instructions that, when executed by one or more processors of a device, cause the device to:
set an initial size of the precision margin to be proportional to a default length of the timeline corresponding to a default zoom level.

17. The non-transitory computer-readable medium of claim 15, wherein the length of the timeline is less than a length of the video.

18. The non-transitory computer-readable medium of claim 15, wherein the one or more instructions that, when executed by one or more processors of a device, cause the device to:
under a condition that the cached image is retrieved from the memory of the client device, display the cached image via a user interface of the client device; and
under a condition that corresponding image is retrieved from the server device, display the corresponding image via the user interface of the client device.

19. The non-transitory computer-readable medium of claim 15, wherein the user input indicating the requested time along the timeline of the video is a selection of a visual marker positioned along the length of the timeline corresponding to the requested time along the timeline of the video.

20. The non-transitory computer-readable medium of claim 15, wherein the requested time along the timeline of the video is selected from available times along the timeline of the video that are associated with an event occurring in the video.
